(19) United States
(12) Patent Application Publication
(10) Pub. No.: US 2006/0237885 A1
(43) Pub. Date: Oct. 26, 2006

(54) Active seat suspension

(75) Inventors: Bruno Paillard, Quebec (CA); Jerome Mazoyer, Plaisance du Touch (FR); Patrice Masson, Sherbrooke (CA); Alain Berry, Rock Forest (CA); André Albert, Sherbrooke (CA)

Correspondence Address: LOWE HAUPTMAN BERNER, LLP, 1700 DIAGONAL ROAD, SUITE 300, ALEXANDRIA, VA, 22314, US

(73) Assignee: Baultar I.D Inc., Quebec, Windsor (CA)

(21) Appl. No.: 10/547,762

(22) PCT Filed: Mar. 3, 2004
(86) PCT No.: PCT/CA04/00321

§ 371 Date: May 30, 2006

(30) Foreign Application Priority Data
Mar. 4, 2003 (CA) 2,420,324

(51) Int. Cl. F16F 15/00; B60N 2/02; F16M 13/00

(52) U.S. Cl. 267/140.15; 248/550; 296/65.02; 267/136; 180/89.12

(57) ABSTRACT

An active suspension for a driver seat of a bus or a heavy vehicle which comprises an electric actuator allowing the exertion of the force between the floor of the vehicle and the bottom of the seat. The adjustment of the height of the seat is accomplished by an electric actuator or by an independent mechanical system. A controller generates a control force calculated from measurements obtained by sensors located at different locations on the suspension. Forces exerted by the electric actuator can be relieved by passive element placed in parallel which cannot assume by themselves the role of a suspension for a given application.

### INTRODUCTION

The present invention generally relates to an active suspension system for a vehicle driver seat, notably in a buss, a heavy vehicle or a specialized use vehicle, for example, an excavating or forestry equipment, and of which the operator or driver is submitted to vibrations.

### BACKGROUND OF THE INVENTION

It is known that irregularities in roads cause the presence of important vibrations in the driver cab for bus drivers or drivers of heavy vehicles such as trucks or specialized use vehicles, for example, excavating or forestry equipment. Exposures of drivers to these vibrations make the exercise of their work uncomfortable and can have a negative influence on their health. In order to reduce the acceleration transmitted to the level of the driver's seat, a suspension is often introduced between the vehicle floor and the seat. The seat suspension must minimize the acceleration transmitted to the driver, but must also maintain minimal the gap in position between the seat and the floor with respect to chosen height adjustment so that the position of the driver with respect to his driving area (steering wheel, pedals . . . ) does not vary too significantly. The design of the suspension must therefore take into account this compromise. Therefore, a very soft suspension will allow a considerable reduction in the level of transmitted acceleration, but at the cost of a significant relative displacement. However, a suspension that is too stiff will maintain a good interaction between the driver and his driving area, but will only offer a weak reduction in the transmitted acceleration.

When taking into account the two above-mentioned requirements, it is possible to determine qualitatively the characteristics that must possess the transmissibility of a suspension in the frequency domain. Given that the positional excitation signal relative to the acceleration excitation signal is more important at lower frequencies, (the amplitude of an harmonic signal with respect to it's second derivative is inversely proportional to the square of the frequency), to be efficient, a seat suspension must have an almost unitary transmissibility at lower frequencies because the influence of the position is dominating at those levels, and almost null at high frequencies where in this case the acceleration transmitted to a seat can be reduced without creating a significant relative displacement between the seat and the floor.

In the case of passive suspensions comprising a spring element and a damping element as illustrated in the FIGS. 1 and 2, there are only two parameters (stiffness and dampening) that can be adjusted and that determine the behaviour of the whole suspension. Back or health problems observed despite the use of this type of suspension demonstrate that passive suspensions do not allow to reach a sufficient level of comfort.

To obtain better performances than that of passive systems, alternative solutions have already been considered.

Thus, semi-active systems have been proposed, in which the functional principle generally consists of modifying in real time the dampening of the suspension according to the magnitudes (position, velocity, acceleration . . . ) that can be measured in real time by sensors placed on the suspension.

Semi-active systems of the type mentioned-above have already been implemented for various applications, in particular for the suspension of seats of vehicles (see patent FR-A-2 761 643; see also the article by Choi, S. B. et al, A semi-active suspension using ER fluids for a commercial vehicle seat, Journal of intelligent material systems and structures, vol. 9—August 1998). Certain studies (see the article of Boileau, P. E. et al, Essais en vibration de sièges pour autobus urbains. Phase 2: Évaluation de sièges candidats, IRSST, June 1997) demonstrate however that their performance in this use is not appreciably better than the performance of passive suspension having fixed dampening.

Active systems have also been proposed, in which the functional principle consists of introducing an actuator that applies in real time a force to the seat in a matter such that the desired response is created at the level of the seat. As opposed to semi-active suspensions that are only dissipative, active systems can inject energy into the system. It is generally admitted that performance of active systems is superior to that of semi-active systems.

Active systems of the type mentioned above have also already been applied, but namely to suspensions of vehicles. These systems have been, in the great majority, put into practice with the help of hydraulic actuators that present several inconveniences, notably of being voluminous, of having a high cost and an excessive consumption of energy and requiring delicate maintenance. These hydraulic actuators can be replaced by electric actuators for vehicle suspensions (see patent U.S. Pat. No. 5,060,959).

Active suspensions have also been considered for seats. These use:
Hydraulic actuators (see the article by Stein, G. J. et al, Active vibration control system for the driver's seat for off-road vehicles, Vehicle system dynamics, 20 (1991), pp. 57-78);
Electrical actuators (see the article by Kawana, M. et al, Active suspension of truck seat, Shock and Vibration 5 (1998), pp. 35-41; or the thesis of Périsse, J., Étude, conception et réalisation d'une suspension active d'un siège de véhicule routier pour l'amélioration du contort dynamique, doctoral thesis, École centrale de Lyon, 1997);
Electropneumatic actuators (see the article by Stein, G. J., A driver's seat with active suspension of electropneumatic type, Transactions of the ASME, vol. 119, April 1997);
Piezoelectric actuators (see the article by Leo. D. J., Active seat isolation for hybrid electric vehicles, SPIE, vol. 3674, March 1999).

In the majority of the presented solutions and for all systems using an electric actuator, the active suspension is implemented in parallel with a traditional passive suspension (see FIG. 3). Moreover, the configuration of this type of passive suspension is such that it could function autonomously, without the presence of an electric actuator. This type of configuration implies that the elements that comprise these passive suspension systems, that are notably the spring element and the dampening element, possess characteristics that cause a passive transmission path between the floor of the vehicle and the base of the seat which is relatively important, resulting thus in relatively high values of stiffness and dampening.

The disadvantage related to active suspension systems that are coupled in parallel with a traditional passive suspension, that is to say capable of functioning autonomously and having relatively high values for stiffness and dampening, are the following:
1. When the passive elements are significant, they act on all of the frequency bandwidth, and therefore the controller, so that the suspension can be effective, must compensate this passive transmission path over the complete bandwidth, which is difficult to realize in practice given that the presence of noise on the sensors limits the useful bandwidth of the controller.
2. The performances of the control law are reduced because of a higher uncertainty on the parameters of the passive suspension. Indeed, since the characteristics of the passive components are known with a certain relative precision, reducing the nominal passive transmission path allows a reduction in the uncertainty on its value, and therefore allows to obtain in practice a suspension behaviour with a better performance.
3. The force that the actuator must provide to compensate the transmission path can be higher, given that it must act at higher frequencies. At low frequencies, the actuator must also provide forces to restrain the amplification around the natural frequency of the suspension system; however, the passive transmission path allows nevertheless a reduction in the force required from the actuator at lower frequencies, notably with respect to the static weight of the operator and the seat.

### SUMMARY OF THE INVENTION

An object of the present invention is to propose an active suspension system which overcomes the above-mentioned problems.

More specifically, the object of the present invention is to provide an active suspension for a vehicle driver seat, such for use on a bus, a heavy vehicle or a specialized use vehicle, for example excavating equipment or forestry equipment, in which the operator or the driver is submitted to vibrations, and that comprises an electric actuator allowing to exert a force between the vehicle floor and the seat. The adjustment of the height of the seat is accomplished by an electric actuator or by an independent mechanical system. A controller generates a force command calculated from measurements obtained by sensors placed at different locations on the suspension. A preferred embodiment of the present invention considers the possibility of placing in parallel to the active suspension, passive suspension elements that offer a low passive transmission path at high frequencies comparatively to a traditional passive suspension that is optimized for a given application. These passive elements allow a reduction in the size of the actuator. In the present invention, the value of the passive elements is such that these cannot ensure alone the role of a suspension for a given application.

A non-restrictive description of preferred embodiments of the invention will now be given with reference to the appended drawings.

### BRIEF DESCRIPTION OF DRAWINGS

In the appended drawing:

FIG. 1 identified as prior art is a schematic representation of the operation of a spring-damper passive suspension;

FIG. 2 identified as prior art is a graph illustrating the transmissibility of a spring-damper passive suspension;

FIG. 3 identified as prior art is a schematic representation of an active seat with a passive suspension in parallel with an actuator;

FIG. 4 is a schematic representation of the principle of an active levitation seat;

FIG. 5 is a graph taken from the above mentioned article by Boileau, P. E. et al., which illustrates the spectral density of the vertical acceleration at the base of the seat of a bus;

FIG. 6 is a perspective view, from below, of the suspension system with height adjustment, in the case of a rotating electric motor, according to a first preferred embodiment of the invention;

FIG. 7 is a side view of the suspension system with height adjustment, in a high position, according to a first preferred embodiment of the invention;

FIG. 8 is a side view of the suspension system with height adjustment, in a low position, according to a first preferred embodiment of the invention;

FIG. 9 is a side view showing the set suspension-seat of the first preferred embodiment of the invention;

FIG. 10 is a prospective view showing the set suspension-seat in a low position, according to a second preferred embodiment of the invention;

FIG. 11 is a prospective view showing the set suspension-seat in a high position, according to a second preferred embodiment of the invention;

FIG. 12 is a perspective view showing the functioning of the transmission mechanism using pulleys and timing belts, according to a second preferred embodiment of the invention; and

FIG. 13 is a perspective view showing the functioning of another preferred embodiment of the compensation system using a compression spring system.

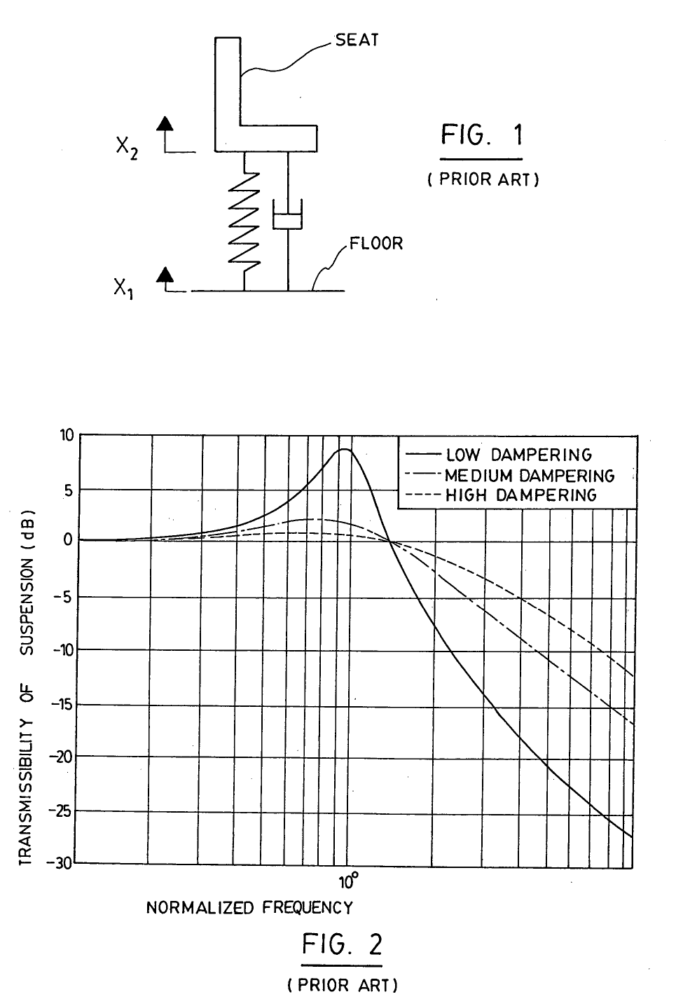

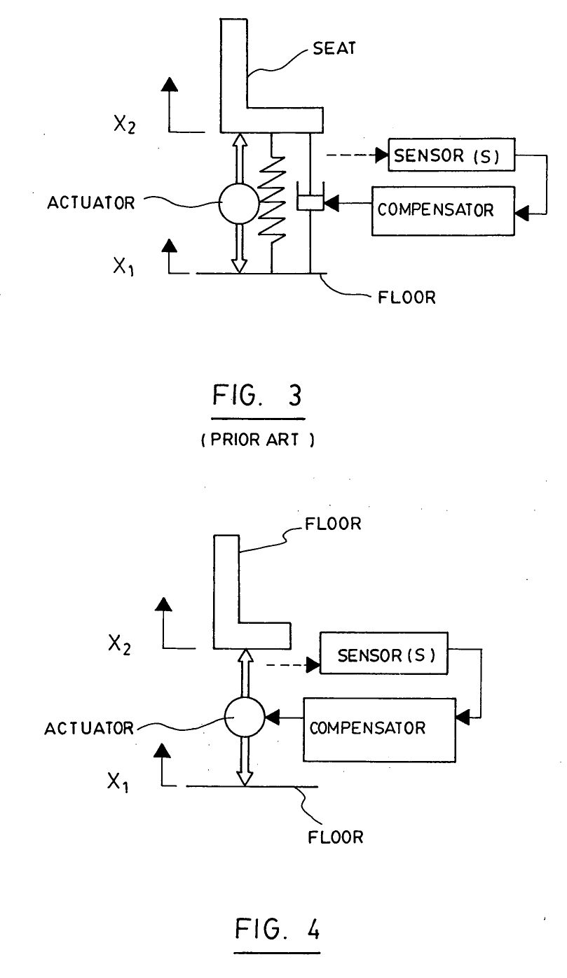

### DESCRIPTION OF PREFERRED EMBODIMENT

Thus an object of the present invention is to provide an active levitation seat in which the seat rest on an electric actuator that can exert the force. A schematic illustration of this active suspension system is illustrated in FIG. 4. In practice, the actuator comprises an electric motor. This motor can be chosen among the different types of available electric motors. One or several sensors provide measurements of relevant characteristic elements such as relative position or the relative velocity of the seat with respect to the floor, the acceleration of the floor, the acceleration of the seat, and these informations are used to control the actuator. The control loop includes a compensator which generates the command for the actuator.

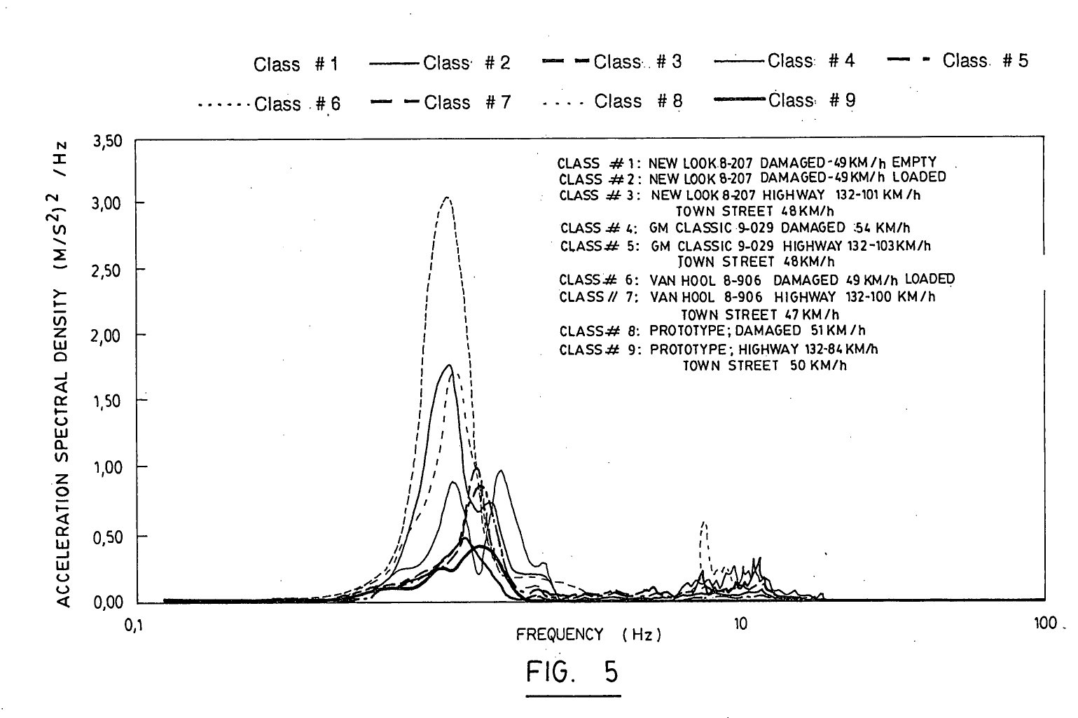

The control law is optimized by taking into account the specific characteristics of the measured perturbations at the floor of the vehicle being considered, for example based on the spectral content of the vibrations present at the floor (see FIG. 5). In a preferred embodiment of the invention, a theory using a linear optimal control law is used. In another preferred embodiment, a non linear optimal control theory is used. In another preferred embodiment, an adaptive control law is used (a control law that can adapt itself as a function of the evolution in the characteristics of the floor acceleration or as a function of the change in mass of the driver present on the seat). In another preferred embodiment, the control law is a combination of several of the previously mentioned laws.

Obviously, vibratory discomfort manifests itself also for drivers of other types of vehicles such as truck or heavy vehicles. The characteristics of the acceleration signal present at the floor varies from one vehicle to another, but the invention can be applied to these different cases.

The present invention therefore proposes a slaved system as illustrated in FIG. 4. However, in order to limit the size and therefore the cost of the actuator, the present invention considers also the possibility of joining in parallel to the actuator, passive suspension elements that present a low passive transmission path at high frequencies relatively to traditional passive suspensions optimized for the given application. Given that, the traditional passive suspension optimized for a particular application is that which minimizes the transmitted acceleration for a relative displacement equal to the maximum acceptable relative displacement, and given that the decrease in the passive transmission path at high frequencies is linked to a “softening” of the passive suspension, therefore the value of the passive elements in the context of the present invention is such that the maximum relative displacement constraint of the driver with respect to his driving area cannot be respected without the joint use of an actuator.

This type of passive suspension is characterized among other things by the presence of a spring element having low stiffness and elements in rotational movement, if need be, having low inertia.

The presence of a spring element allows to generate an upwards force in order to completely or partly compensate, the static weight of the operator in the seat. The actuator therefore does not have to support this weight which is taken care of by the spring element, which contributes to the reduction of its size. The apparatus comprising the spring element and fixation means is designated hereafter in this text by the expression compensation system.

The compensation system of the preferred embodiment of the invention is only present to reduce a given value of static weight imposed on the motor. This given value can either include the total static weight of the driver and the part of the seat situated above the suspension, or only a fraction of this static weight. In this last case, the resulting static weight seen by the motor corresponds to the weight of the part of the seat located above the suspension plus the weight of the driver minus the force generated by the compensation system. Always according to this last case, the resultant static weight that the motor sees and must equilibrate, will be little or not variable over the complete range of movement of the suspension.

The option of adding a passive suspension having low transmissibility at high frequencies, in parallel to the actuator, requires that the rotational passive elements have a low inertia. This inertia comprises for example the rotational inertia of the members of a suspension guiding system such as that in the shape of scissors, as seen in passive traditional suspension systems. It can also be question of the inertia of a mechanical transmission system that converts a rotational movement of the actuator into a vertical movement of the seat, in cases where a rotational motor is used as an actuator.

This rotational motor will also offer a minimal rotational inertia in order to optimally reduce the torque required by the motor.

According to a preferred embodiment of the invention, the compensation system is a groupe of tension springs that are installed in the shape of a U. A lateral displacement of the extremities of the spring or springs allows to obtain a reaction force on behalf of the spring which is practically constant whatever the value of the displacement may be; this corresponds to a very low spring stiffness. It is possible to understand better the functioning of this type of springs with the help of the description provided below with respect to the appended figures.

According to another preferred embodiment of the invention, a compression spring system connected to a lever with a cable, is equivalent to a compensation system having low stiffness which provides a torque for balance of the seat-driver load whatever the position of the seat in its suspension movement may be. The torque generated by the spring-lever system is relatively constant due to the fact that the lever, somewhat similar to a quarter of a pulley, possesses a radius which varies in accordance with the rotational angle of the lever, and in which the value of this radius has been designed in order to allow a relatively constant torque whatever the spring compression may be (that is to say whatever the position of the seat in its suspension movement may be). Indeed, the torque generated by the system, which can be calculated as a product of the force generated by the spring multiplied by its lever arm, that is to say the radius of the lever, is therefore relatively constant. It will also be possible to better understand the functioning of this mechanism with the help of the description presented below at example 2.

In accordance with this last preferred embodiment of the invention, it is also possible to render adjustable the compensation system such that the system can balance at all times the weight of the seat and its occupant. In this case, if a conductor having a given weight sits on the seat-suspension system, then the system will balance relatively precisely the value of this driver's weight, and to which is added the weight of the seat, and this in a relatively constant manner over the complete range of motion along the height of the suspension. Therefore, the sizing of the motor can only consider the requirements related to the dynamic forces that it must transmit. One obtains this adjustment in the force or the torque, as a function of the weight of the operator by moving the base of the spring or springs through mechanical, electric or pneumatic means.

According to a preferred embodiment of the invention, it is possible to obtain the functionality of the low stiffness and adjustable compensation system, through pneumatic system means. Indeed, an easy way to obtain a constant force or pressure may consists among other things to connect a pneumatic cylinder having an air chamber, and having a volume much superior than the variations in volume caused by the displacement of the cylinder. Consequently, the force exerted by the cylinder is practically constant no matter what the position of the piston in the cylinder is, since the variations in the volume of air in the complete system are considered to be negligible. The adjustment as a function of the weight of the driver of the reaction force exerted by the cylinder can be accomplished by acting on the fill pressure of the cylinder and chamber system.

The pneumatic cylinder of the preceding preferred embodiment can also be replaced by an air spring. In this last case however, the choice of the air spring is such that it must present a sufficiently constant force over the range of the desired heights when the pressure is maintained almost constant, as described previously. It may also be possible to select an air spring that offers a low stiffness or a low variation in force as a function of the displacement of the seat in the range of the height, without being linked to a chamber.

In accordance with a preferred embodiment of the invention, the height adjustment system is independent from the suspension. A scissor mechanical system is superimposed on the suspension mechanism for adjustment of the height. One of the advantages related to this configuration is that given a break in the suspension or a problem with the actuator, the fall of the seat is limited to the value of the range of motion of the suspension, which represents a much lower value than the range of motion in height.

However, in accordance with another preferred embodiment of the invention, the actuator can be used also as a mechanism for adjustment of the height. In this last case, a security system is provided to stop any fall of the seat in the eventuality of a break or a problem with the actuator for example.

In the case where a rotational electric motor is used, it is necessary to transmit the rotational movement from the motor into the translational movement of the seat. This can be accomplished with different mechanisms such as a rack and pinion, pulleys and toothed transmission belts or with screws and ball nuts. In this last case, the screw is linked to the motor shaft while a ball nut is connected to the element supporting the driver's seat. Therefore, when the motor shaft and the screw connected to it turn in one direction or another, the ball nut which allows a reduction in the friction of the system, as well as the mass supported as linked to this ball nut, will move upwards or downwards.

In the case where the chosen motor is a linear motor, then the translational movement is directly transmitted to the mass being supported, allowing the mass to move upwards or downwards according to the need.

In order to allow the seat to move upwards or downwards without having the actuator being submitted to other strains than those along a vertical axis, a guidance system is used to limit other forces and moments.

In the case where the actuator is a rotational type electric motor, a preferred embodiment of the invention comprises a guidance system comprising an apparatus having pivotally connected members of which the functional principle is presented below and illustrated in the appended drawings.

Also in the case of a rotational electric motor, but also in the case a linear type electric motor, another preferred embodiment of the invention consists in having a guidance system comprising a certain number of vertical members along which linear bearings ensure the displacement of the seat while reducing friction.

### EXAMPLE 1

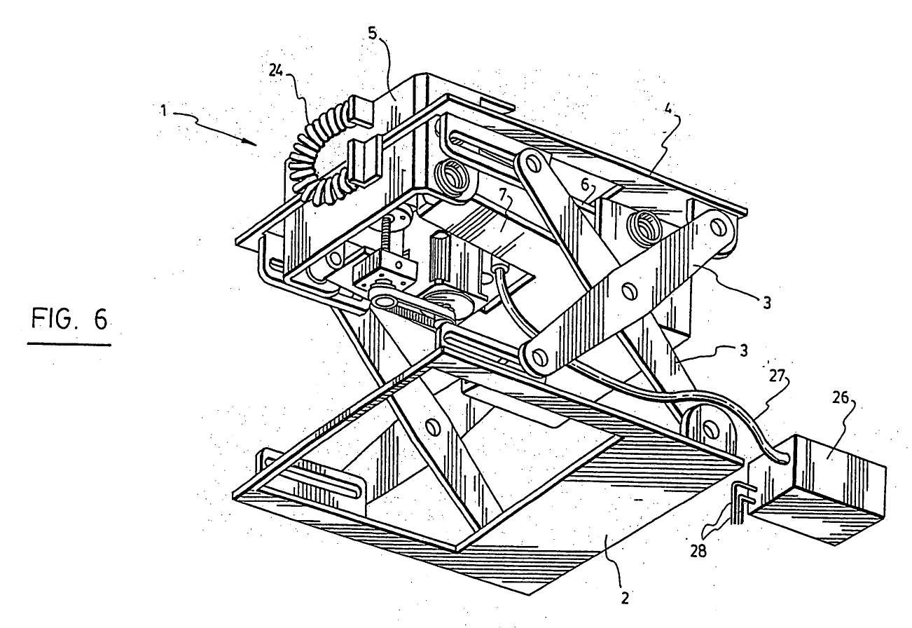

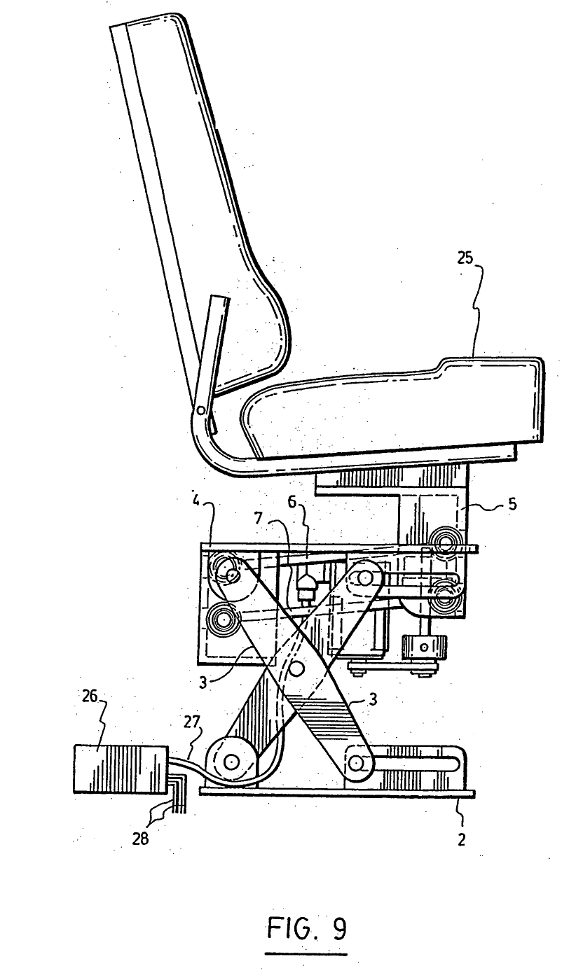

A possible example of a preferred embodiment of the invention is illustrated in FIGS. 6 to 9 of the appended drawings. In this example, the seat 25 is mounted on an overall system 1 combining the height adjustment and the suspension mechanism.

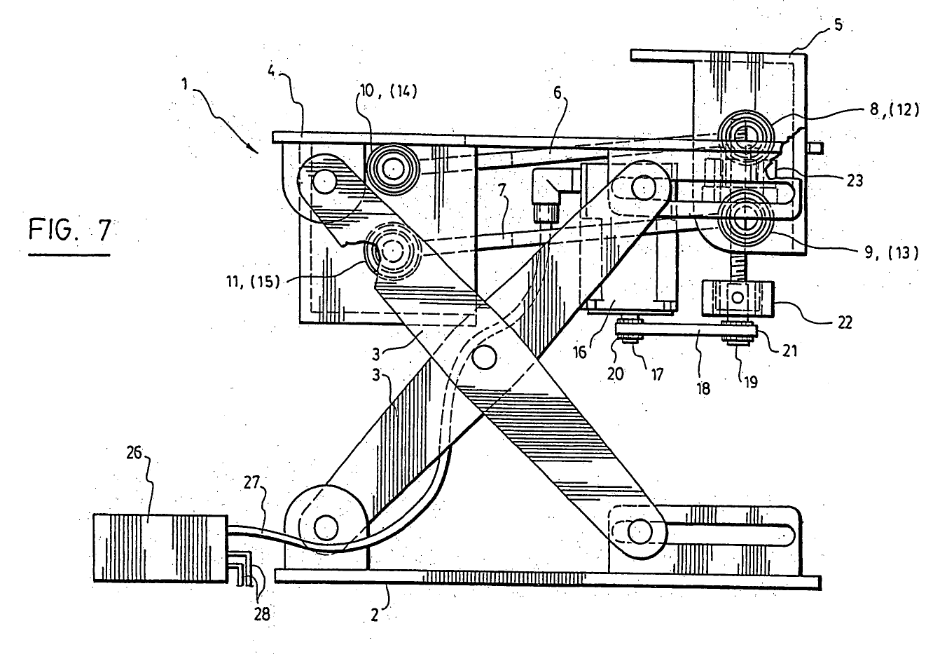

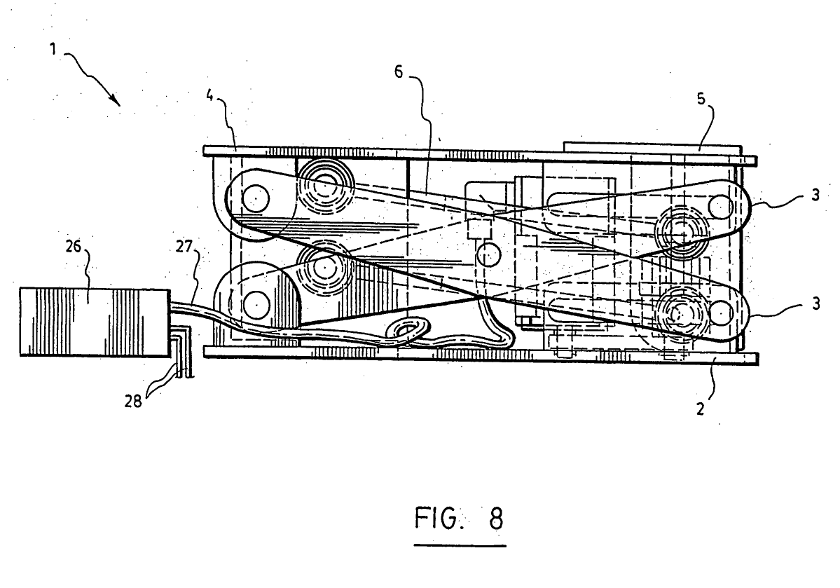

Concerning this, one shall note that the height adjustment mechanism is independent of the suspension mechanism. Indeed, the suspension mechanism is “superimposed” on the mechanical system having members or diagonal braces 3 used in the height adjustment mechanism. The height adjustment mechanism also comprises a base 2 fixed to the floor and an element 4 parallel to the base 2. These two elements 2 and 4 are connected between themselves through the cross member or diagonal brace system 3 mentioned above which allows an elevation of the element 4 with respect to the base 2 when it is activated. FIG. 7 shows a high configuration of the system while FIG. 8 shows a low configuration.

FIG. 7 shows a preferred embodiment of the suspension system used. The suspension system comprises a rotational electric motor 16. Of course, several elements are required in order to transmit the rotational movement of the motor 16 into a translational motion of the seat 25. The preferred embodiment shown uses among other things a ball screw 19 and a ball nut 23.

More particularly, the drive pinion 20 of the shaft 17 of the rotational electric motor 16 is connected to the pinion 21 of the ball screw 19 with a transmission belt 18. The bearing 22 as well as the ball nut 23 are two fixation points for the ball screw 19. The bearing 22 is connected to a top element 4 of the height adjustment mechanism with a fixation element (not illustrated), while the ball nut 23 is connected to the element 5 on which the seat 25 is fixed. Therefore, when the shaft 17 of the motor 16 turns in one direction or the other, the screw 19 turns also in a manner such that the ball nut 23 moves upwards or downwards. Therefore, through the same movement of the ball nut 23, the element 5 as well as the seat 25 which is fixed to the element moves upwards or downwards. Inversely, a vertical motion of the seat 25 and of the element 5 on which it is fixed, will produce a rotation of the shaft 17 of the electric motor 16.

In order to allow the seat 25 to move upwards and downwards without the motor 16 acting as an actuator being submitted to forces other than those generated along the vertical direction, a guidance system is used to limit forces and moments along other directions. In the preferred embodiment shown in FIG. 7, this guidance system comprises a mechanism having pivotally connecting members 6 and 7. This mechanism comprises also a top element 5 on which is fixed a seat 25, and bearings 8, 9, 10, 11, 12, 13, 14, 15. These bearings allow members 6 and 7 to pivot with respect to each other with reduced friction when top element 5 of the suspension moves with respect to top element 4 of the height adjustment mechanism. A consequence related to the geometry of this system is that element 5 is submitted to a horizontal displacement at the same time as to a vertical displacement when the pivotally connected members 6 and 7 rotate. However the dimensions of these elements and members are designed such that the horizontal displacement is negligible with respect to the vertical displacement. This very light horizontal displacement therefore does not affect the performance of the suspension.

Because of the light horizontal displacement mentioned above of the top element 5 of the suspension, it is important that the ball screw 19 is able to pivot in the plan of the figure, at the same time as its two fixation points, the bearing 22 and the ball nut 23. Therefore, the bearing 22 can pivot with respect to a fixation element (not shown) that relates it to the top element 4 of the height adjustment system. Moreover, the ball nut 23 is pivotally connected to the top element 5 of the suspension system to which it is connected. The electric motor 16 being interconnected with element 4, the transmission belt 18 will be submitted to a light bending due to the pivoting of the ball screw 19 as described previously.

As shown in FIG. 6, a spring system 24 is placed in parallel to the motor 16. This spring system 24 allows the generation of a quasi-constant force over the complete range of motion of the suspension. This system is only present to reduce a given value of weight exerted on the motor. Therefore, the result in static weight seen by the motor 16 corresponds to the weight of the seat 25 plus that of the driver minus the quasi-constant force.

The spring system 24 shown in this preferred embodiment of the invention comprises essentially one or several tension type springs that are installed in a U shape, and in which one extremity is connected to the top element 4 of the height adjustment system, while another extremity is connected to the top element 5 of the suspension system. A lateral displacement, that is to say a vertical displacement of the extremities of the spring or springs 24 allows one to obtain a reaction force generated by the spring which is practically constant whatever the value of the displacement may be. This reaction force has therefore the effect of decreasing the apparent weight that the motor 16 must lift.

An optical encoder integrated to the motor 16 casing is used as a sensor to detect the relative position of the seat with respect to the chosen adjustment in height. This optical encoder is connected to an electronic circuit integrated into the casing 26 through isolated electrical lines located in a cladding 27. The casing 26 comprises the control electronics of the compensator allowing the calculation of the force that must be generated by the motor as a function of the relative position provided by the encoder. The casing 26 comprises also the electronics required for the production of the force generated by the motor previously mentioned. The motor 16 windings are connected to the electronic circuit integrated in the casing 26 through other electrical isolated lines and are situated in the cladding 27. The electronic circuit integrated in the casing 26 is fed by the vehicle battery through isolated electrical lines 28.

### EXAMPLE 2

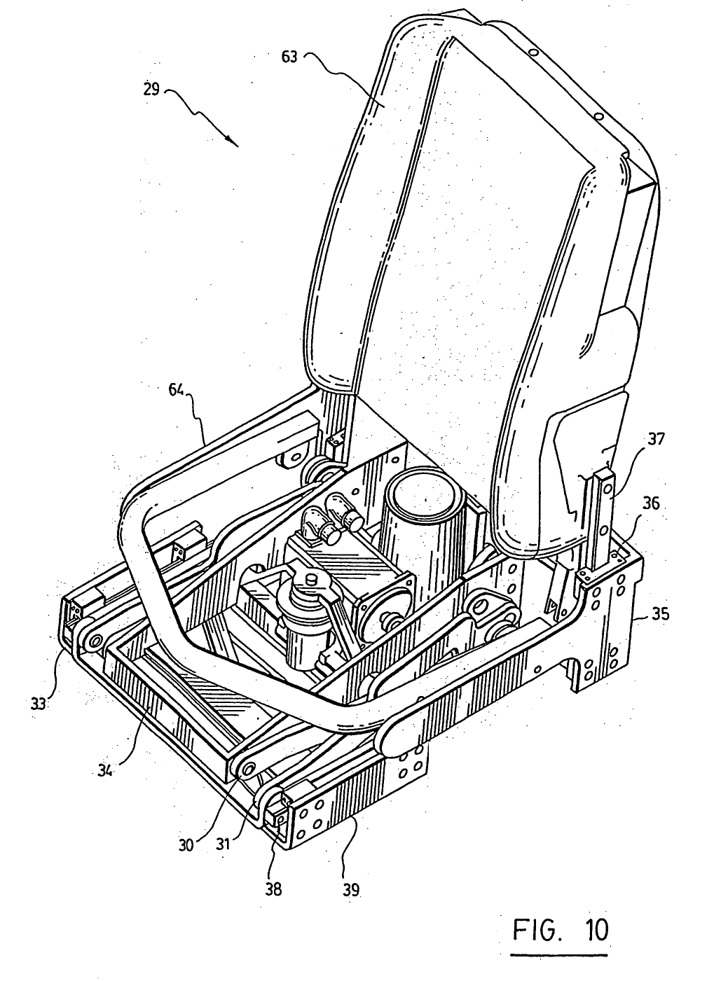

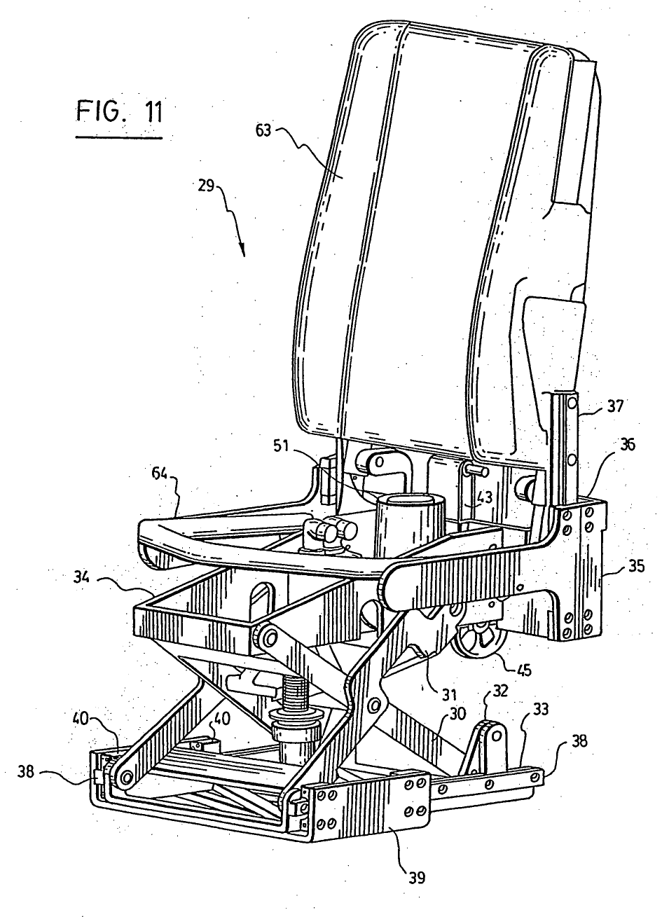

A second example of an embodiment of the invention is illustrated in FIGS. 10 to 12. This example, which is described in the following paragraphs, presents the base of the seat shown in FIGS. 10 and 11 which comprises a guidance mechanism for the suspension superimposed on the height adjustment systems and the forward-backward movement adjustment system for the seat. FIG. 10 shows a seat in a low position, while FIG. 11, shows it in the high position.

As in the previous example, the height adjustment mechanism is independent of the suspension mechanism. The height adjustment mechanism comprises of a scissor-shaped system having pivotally connecting members 30, 31 and 32. These members are the link between the base 33 and element 34. The adjustment in height that allows an elevation of the element 34 with respect to the base 33, is accomplished through relative displacement of members 30, 31 and 32. The displacement of these members 30, 31 and 32 is controlled by mechanical or electrical means not showed.

The suspension stage is located between element 34 and element 35. Element 35 of the suspension represents the structural element on which are fixed the components of the back 63 and the bottom 64 of the seat 29 (the base cushion is not shown).

In this preferred embodiment, the guidance in the movement of the suspension, that is the vertical movement of the support 35 with respect to the element 34 is accomplished through the movement of linear bearings 36 along rails 37. The linear bearings 36 are integral to the support 35, and the rails 37 are integral to the element 34, or vice-versa. These guidance elements ensure that the internal elements of the suspension (motor, transmission and compensation systems) shown in FIGS. 10 to 12 and described below, do not have to support forces in directions different then that of the vertical direction.

FIGS. 10 and 11 show also the mechanism that allows an adjustment forwards-backwards of the seat and its base comprising its height elevation system and its suspension stage as described above. This forwards-backwards adjustment mechanism or slider comprises rails 38 integral to the base 33 and that can be displaced with respect to the element 39 fixed to the floor and having bearings 40.

This preferred embodiment of the invention shown in FIGS. 10 and 11 use an air spring 51 connected to a pressurized chamber (not shown) used as compensation elements that allow a reduction in total or in part of the static weight of the driver and the seat supported by the motor. The force generated by the air spring is exerted between the support 35 and the element 34 of the suspension (the fixation element of the air spring 51 are now shown). The air spring 51 is selected in order to offer a low or very low stiffness with the constant air pressures used. Given that the volume of the chamber is considerably higher with respect to the variations of volume caused by the displacement of the air spring during movement of the suspension, the force exerted by the air spring is relatively constant since the variations in the volume of air of the whole system and therefore of pressure are considered to be negligible. The chamber can be selected to be very small and can even be eliminated, through selection of an air spring having low stiffness over its complete range of motion along the height direction during motion of the suspension and even when used autonomously without the chamber.

The adjustment as a function of the weight of the driver, of the reaction force exerted by the air spring, can be accomplished through control of the filling pressure of the air spring and chamber system. This can be accomplished for example through the use of mechanisms not shown used to collect information on the weight of the driver and the use of valves to control the desired pressure. Of course, a cylinder can be used instead of the air spring 51.

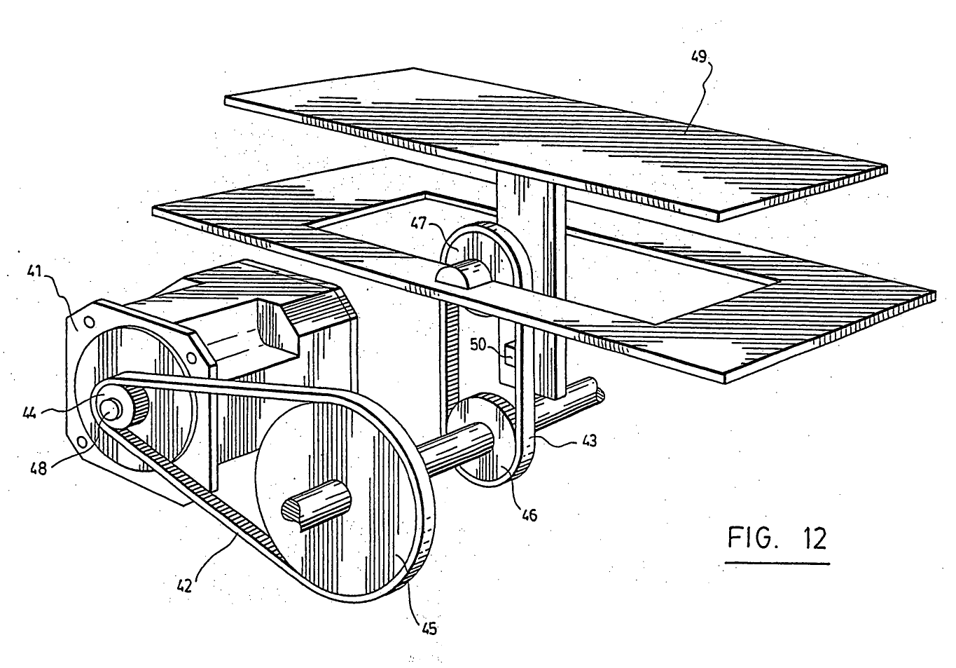

FIG. 12 shows the functioning of the transmission mechanism proposed in this example of a preferred embodiment of the invention and which allows the transfer of a rotational movement of the motor 41 into a linear motion allowing upwards and downwards movements of the seat and of the operator. The transmission mode shown in FIG. 11 uses a system of belts 42 and 43, illustrated symbolically, as well as tooth pulleys 44, 45, 46 and 47. The number of belts, of pulleys and the dimensions of these elements are designed such that desired transmission and inertia ratios are obtained. Therefore, when the shaft 48 of the motor turns in one direction or the other, the belts and toothed pulleys are also displaced. The rotational movement of the shaft 48 of the motor will generate a vertical linear movement of the seat (not shown), since the support 49 on which is mounted the seat is connected integrally with an element 50 to the timing belt 43 installed vertically. Element 50 shown symbolically is in fact an element with teeth that is connected to the timing belt 43.

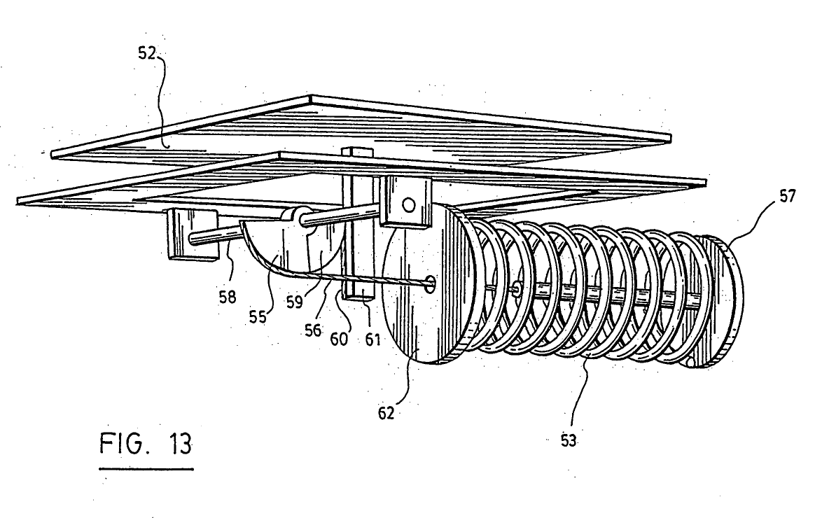

FIG. 13 shows the functioning of another embodiment of the compensation mechanism that allows a reduction of the weight felt by the motor. This mechanism that allows the generation of a torque that is relatively constant over the complete range of motion of the suspension, functions in the following manner:

When the support 52, on which the feet is fixed (not shown) moves upwards and downwards to allow an attenuation in the vibrations and the shocks transmitted by the floor of the vehicle, the compressed length of the spring 53 varies, which allows the spring 53 to generate a force proportional to its compressed length (F=−kx). An extremity of the spring 53 is connected to a point of the lever 55 through the means of a cable and a fixation element 57 located at the extremity of the spring. The other extremity of the spring 53, held back by a fixation element 62 is integral to the base not shown located below the suspension mechanism. The radius of the lever 55 varies with its angular position. This radius which represents the lever arm generated by the spring 53, is calculated such that the cable 56 which transmits the force of the spring 53 produces a torque which is relatively constant with respect to the pivot 58 of the lever 55. The pivot 58 is also integral to another lever 59, having a constant radius, to which is fixed the extremity of a second cable 60. The other extremity of this cable 60 is anchored to the base of a vertical member 61 which is integral to a support 52 of the seat not shown. The weight of the driver and of the seat fixed on the support 52 therefore generates a torque with respect to the pivot 58, via the force transmitted to the cable 60 which acts with the lever arm equal to the radius of the lever 59. Since this radius is constant no matter what the angular position of the shaft may be, the torque created by the load of the driver and the seat is therefore constant over the complete range of motion of the suspension. This torque load submitted at the pivot 58 is therefore balanced by the torque generated by the spring 53. Of course, a similar mechanism can also be devised by an extension spring instead of a compression spring.

In accordance with the preferred embodiment shown in this example, it is also possible to make adjustable the force generation system or the torque generation system which is relatively constant in a manner such that it can always balance the weight of the seat and its occupant. This can be accomplished simply by positioning the fixation element 62 such that the compressed length of the spring 53 is changed and therefore the torque generated by the spring is changed also. The displacement of the fixation element 62 can be accomplished through a pneumatic, electric or other mechanism following the detection of the weight of the operator-seat to be balanced. The detection of this weight can be made with the help of a sensor, with a load cell or any other mechanism known for this task.

1. An active suspension for a driver seat of a vehicle, said seat comprising a bottom, said vehicle comprising a floor, wherein the suspension comprises:
a. an electric actuator mounted between the floor of the vehicle and the seat such that the actuator exerts a force between said floor and the bottom of the seat; and
b. a controller connected to the electric actuator to generate a control signal calculated from measurements obtained by at least one sensor.

2. The active suspension according to claim 1, wherein the active suspension further comprises:
a mechanical system independent of the electrical actuator to adjust the height of the seat.

3. The active suspension according to claim 1, wherein the active suspension further comprises:
an elastic element having a low passive transmission path at high frequencies, capable of generating a force upwards on the bottom of the seat, having little variation when the seat displaces itself in the range of motion of the suspension and that supports at least a part of the static loads of the driver and the seat supported by the electric actuator.

4. The active suspension according to claim 3, wherein the elastic element comprises at least one tension spring installed in a manner to have a U-shape.

5. The active suspension according to claim 3, wherein the elastic element comprises a pneumatic cylinder.

6. The active suspension according to claim 5, wherein the pneumatic cylinder is connected to a chamber filled with air, said chamber having a volume much superior to the variations in volume caused by the displacement of the cylinder and wherein the active suspension further comprises a system of displacement sensors located around an equilibrium position of the seat, within the range of motion of the suspension, which is connected to a system of valves in order to allow a control of the pressure of the chamber and cylinder system and to allow adjustment of the force exerted by the cylinder as a function of the weight of the driver.

7. The active suspension according to claim 3, wherein the elastic element is an air spring.

8. The active suspension according to claim 7, wherein the air spring is connected to a chamber filled with air, said chamber having a volume much superior to the variations in volume caused by the displacement of the air spring and wherein the active suspension further comprises a system of displacement sensors located around an equilibrium position of the seat, within the range of motion of the suspension, which is connected to a system of valves in order to allow a control of the pressure of the chamber and air spring system and to allow adjustment of the force exerted by the air spring as a function of the weight of the driver.

9. The active suspension according to claim 3, wherein the elastic element comprises a compression spring system connected to a lever through a cable, said lever, shaped as a part of a pulley, having a variable radius with respect to the angle of rotation, and in which the value of the radius is designed in order to allow a relatively constant torque independent of the compression of the spring and of the position of the seat in the range of travel of the suspension and said compression spring system being further connected to a mobile base in which the position is controlled by positioning means to adjust the force exerted by the spring system as a function of the weight of the operator.

10. The active suspension according to claim 1, wherein the electric actuator is a rotational electric motor.

11. The active suspension according to claim 10, wherein the active suspension further comprises:
a transmission system for transferring the rotational movement of the motor into a translational movement of the seat, said transmission system comprising belts and toothed pulleys having low inertia.

12. The active suspension according to claim 10, wherein the active suspension further comprises:
a transmission system for transferring the rotational movement of the motor into a translational movement of the seat, said transmission system comprising a system of ball screws and ball nuts having low inertia.

13. The active suspension according to claim 1, wherein the active suspension further comprises:
a guidance system comprising linear guides that allow the seat to move upwards or downwards without submitting the actuator to forces others than those along vertical axis.

14. The active suspension according to the electric actuator is a linear electric motor.

15. The active suspension according to claim 1, wherein the electric actuator allows an adjustment in the height of the seat, as well its contribution to the suspension.

16. A vehicle comprising the active suspension for the driver seat of claim 1.

17. The vehicle according to claim 16, which is a bus.

18. The vehicle according to claim 16, which is a specialized use vehicle.

19. The vehicle according to claim 18, wherein the specialized use vehicle is a excavating vehicle.

20. The vehicle according to claim 18, wherein the specialized use vehicle is a forestry vehicle.
